(19) United States
(12) Patent Application Publication
(10) Pub. No.: US 2020/0172317 A1
(43) Pub. Date: Jun. 4, 2020

(54) BOX HAVING SEALING LID WITH PERFORATED TEAR STRIP

(71) Applicant: THATBOX DESIGN, LLC, FORT MILL, SC (US)

(72) Inventor: Donn J. Costanzo, JR., Fort Mill, SC (US)

(21) Appl. No.: 16/786,958

(22) Filed: Feb. 10, 2020

Related U.S. Application Data
(63) Continuation-in-part of application No. 15/646,053, filed on Jul. 10, 2017.
Application No. 15/646,053 is a continuation of application No. 15/289,189, filed on Oct. 9, 2016, now Pat. No. 9,701,089.
Application No. 15/289,189 is a continuation of application No. 14/059,430, filed on Oct. 21, 2013, now Pat. No. 9,475,247.
Application No. 14/059,430 is a continuation of application No. 13/049,890, filed on Mar. 16, 2011, now Pat. No. 8,562,499.
(60) Provisional application No. 61/452,640, filed on Mar. 14, 2011.

(51) Int. Cl. B65D 81/38; B65D 25/20; B65D 5/42; B65D 5/20; B65D 5/56; B65D 5/46; B65D 5/24; B31B 50/26

(52) U.S. Cl. CPC B65D 81/386; B65D 25/205; B65D 5/4266; B65D 5/20; B31B 2120/30; B65D 5/563; B65D 5/46112; B65D 5/241; B31B 50/26; B65D 5/2047

(57) ABSTRACT

A box has a bottom panel, first and second side panels, a front panel, and a rear panel defining an interior space of the box, and a top panel serving as a lid covering the interior space. The top panel includes a front tab having an adhesive strip laterally extending across a distal portion of the front tab for securing the front tab to the front panel when the lid covers the interior space; and lines of perforations extending across a proximal portion of the front tab, the lines of perforation defining a tear strip for releasing the top panel from the front panel. The adhesive strip comprises a protective peelable liner. The adhesive strip extends completely across the proximal portion of the front tab from the first lateral side to the second lateral side.

### CROSS-REFERENCE TO RELATED APPLICATIONS

The present application is a continuation-in-part of application Ser. No. 15/646,053 filed 2017 Jul. 10, incorporated herein by reference; which '053 application is a continuation of Ser. No. 15/289,189 filed 2016 Nov. 09, incorporated herein by reference, now U.S. Pat. No. 9,701,089, incorporated herein by reference; which '189 application is a continuation of Ser. No. 14/059,430 filed 2013 Oct. 21, incorporated herein by reference, now U.S. Pat. No. 9,475,247, incorporated herein by reference; which '430 application is a continuation of Ser. No. 13/049,890 filed 2011 Mar. 16, incorporated herein by reference, now U.S. Pat. No. 8,562,499, incorporated herein by reference; which '890 application is a nonprovisional of, and claims priority under 35 U.S.C. 119(e) to, Ser. No. 61/452,640 filed 2011 Mar. 14, incorporated herein by reference.

### COPYRIGHT STATEMENT

Any new and original work of authorship in this document is subject to copyright protection under the copyright laws of the United States and other countries. Reproduction by anyone of this document as it appears in official governmental records is permitted, but otherwise all other copyright rights whatsoever are reserved.

### BACKGROUND OF THE INVENTION

The present invention generally relates to apparatus and methods in the field of boxes and, in particular, boxes, blanks, and methods of making boxes each having a sealing lid with a perforated tear strip.

### SUMMARY OF THE INVENTION

The present invention includes many aspects and features. Moreover, while many aspects and features relate to, and are described in, the context of corrugated boxes, the present invention is not limited to use only in such context, as will become apparent from the following summaries and detailed descriptions of aspects, features, and one or more embodiments of the present invention.

Accordingly, in an aspect of the invention, a box comprises a sheet material defining a bottom panel; first and second side panels, the first side panel being on a first lateral side of the box and the second side panel being on a second lateral side of the box opposite to the first lateral side; a front panel; a rear panel; and a top panel. The bottom panel, first and second side panels, front panel, and rear panel define an interior space of the box, and the top panel defines a lid covering the interior space. The top panel comprises a front tab. The front tab comprises an adhesive strip laterally extending across a distal portion of the front tab for securing the front tab to the front panel when the lid covers the interior space; and lines of perforations extending across a proximal portion of the front tab, the lines of perforation defining a tear strip for releasing the top panel from the front panel.

In a feature, the adhesive strip comprises a protective peelable liner.

In a feature, the adhesive strip extends completely across the proximal portion of the front tab from the first lateral side to the second lateral side.

In a feature, the lines of perforations are parallel.

In a feature, one of the lines of perforations separates and defines a boundary between the top panel and the front tab.

In a feature, the tear strip defines a gripping portion for initiating tearing of the tear strip along the parallel lines of perforations.

In a feature, the gripping portion comprises a protuberance that extends beyond a lateral side edge of the front tab.

In a feature, a fold line extends and defines a common boundary between the rear panel and the bottom panel.

In a feature, a fold line extends and defines a common boundary between the front panel and the bottom panel.

In a feature, a fold line extends and defines a common boundary between the first side panel and the bottom panel.

In a feature, a fold line extends and defines a common boundary between the second side panel and the bottom panel.

In a feature, a fold line extends and defines a common boundary between the rear panel and the front tab.

In a feature, the first side panel comprises two subpanels having a fold line extending and defining a common boundary therebetween. Preferably, the first side panel further comprises two flange subpanels having a fold line extending and defining a common boundary therebetween; and the second side panel comprises two subpanels having a fold line extending and defining a common boundary therebetween, wherein the second side panel further comprises two flange subpanels having a fold line extending and defining a common boundary therebetween.

In a feature, the sheet material further defines first and second connecting panels, each of the first and second connecting panels having a respective fold line extending and defining a boundary between it and the first side panel.

Preferably the sheet material further defines third and fourth connecting panels, each of the third and fourth connecting panels having a respective fold line extending and defining a boundary between it and the second side panel, wherein the first connecting portion further comprises a flange subpanel having a fold line extending and defining a boundary between it and the first connection portion, and wherein the third connecting portion further comprises a flange subpanel having a fold line extending and defining a boundary between it and the second connection portion.

In a feature, the sheet material is corrugated.

In a feature, the sheet material is corrugated cardboard.

In a feature, the perforations extend through the sheet of material.

In a feature, the perforations do not extend through the sheet of material.

In a feature, the bottom panel comprises minor score lines facilitating collapsing of the box when in an assembled state.

In another aspect, a method of making a box blank comprises: forming fold lines in a single sheet of material such that the single sheet of material comprises a bottom panel; first and second side panels, the first side panel being on a first lateral side of the box and the second side panel being on a second lateral side of the box opposite to the first lateral side; a front panel; a rear panel; a top panel; and a front tab, wherein the front tab is connected to the top panel with a first line of perforations and wherein the front tab further comprises another line of perforations extending across a proximal portion of the front tab, the lines of perforations defining a tear strip. The method further comprises adhering an adhesive strip to a distal portion of the front tab such that the adhesive strip laterally extends across the distal portion of the front tab from the first lateral side to the second lateral side.

In another aspect, a method of securing an aforementioned box for shipping comprises folding the top panel into covering relation to an interior space defined by the side panes, rear panel, front panel, and bottom panel; and adhering the distal portion of the front tab of the top panel to the front panel.

In a feature, the method further comprises peeling off the liner from the adhesive strip, folding the front tab over a top edge of the front panel, and pressing the adhesive strip on the distal portion of the front tab into engagement with an outer surface of the front panel to secure the front tab to the front panel and the top panel in covering relation to the interior space of the box.

In addition to the aforementioned aspects and features of the present invention, it should be noted that the present invention further encompasses the various logical combinations and subcombinations of such aspects and features. Thus, for example, claims in this or a divisional or continuing patent application or applications may be separately directed to any aspect, feature, or embodiment disclosed herein, or combination thereof, without requiring any other aspect, feature, or embodiment.

### BRIEF DESCRIPTION OF THE DRAWINGS

One or more preferred embodiments of the present invention now will be described in detail with reference to the accompanying drawings, wherein the same elements are referred to with the same reference numerals.

FIG. 1 is a perspective front view of a preferred embodiment of a box in accordance with one or more aspects and features of the invention.

FIG. 2 is a perspective side view of the box of FIG. 1.

FIG. 3 is a rear perspective view of the box of FIG. 1.

FIG. 4 is a close-up view of a portion of the underside of the top panel of the box of FIG. 1 showing a front tab having an adhesive sealing strip and a tear-off portion defined by lines of perforations.

FIG. 5 is a schematic illustration of a box blank for making the box of FIG. 1.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once but not necessarily every time during performance of the claimed method.

Furthermore, it is important to note that, as used herein, “comprising” is open-ended insofar as that which follows such term is not exclusive. Additionally, “a” and “an” each generally denotes “at least one” but does not exclude a plurality unless the contextual use dictates otherwise. Thus, reference to “a picnic basket having an apple” is the same as “a picnic basket comprising an apple” and “a picnic basket including an apple”, each of which identically describes “a picnic basket having at least one apple” as well as “a picnic basket having apples”; the picnic basket further may contain one or more other items beside an apple. In contrast, reference to “a picnic basket having a single apple” describes “a picnic basket having only one apple”; the picnic basket further may contain one or more other items beside an apple. In contrast, “a picnic basket consisting of an apple” has only a single item contained therein, i.e., one apple; the picnic basket contains no other item.

When used herein to join a list of items, “or” denotes “at least one of the items” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers”; the picnic basket further may contain one or more other items beside cheese and crackers.

When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”; the picnic basket further may contain one or more other items beside cheese and crackers.

The phrase “at least one” followed by a list of items joined by “and” denotes an item of the list but does not require every item of the list. Thus, “at least one of an apple and an orange” encompasses the following mutually exclusive scenarios: there is an apple but no orange; there is an orange but no apple; and there is both an apple and an orange. In these scenarios if there is an apple, there may be more than one apple, and if there is an orange, there may be more than one orange. Moreover, the phrase “one or more” followed by a list of items joined by “and” is the equivalent of “at least one” followed by the list of items joined by “and”.

Furthermore, as used herein, “fold line” means lines of weakness formed in the sheet material of the blank or box. The lines of weakness may comprise perforations from cutting or punching formed in the sheet material, or score lines from slicing the sheet material, or other lines made in the sheet material that facilitate folding there along. In preferred embodiments, fold lines separate and define panels. In the drawings, dashed lines represent the fold lines.

Referring now to the drawings, one or more preferred embodiments of the invention are next described. The following description of one or more preferred embodiments is merely exemplary in nature and is in no way intended to limit the invention, its implementations, or uses.

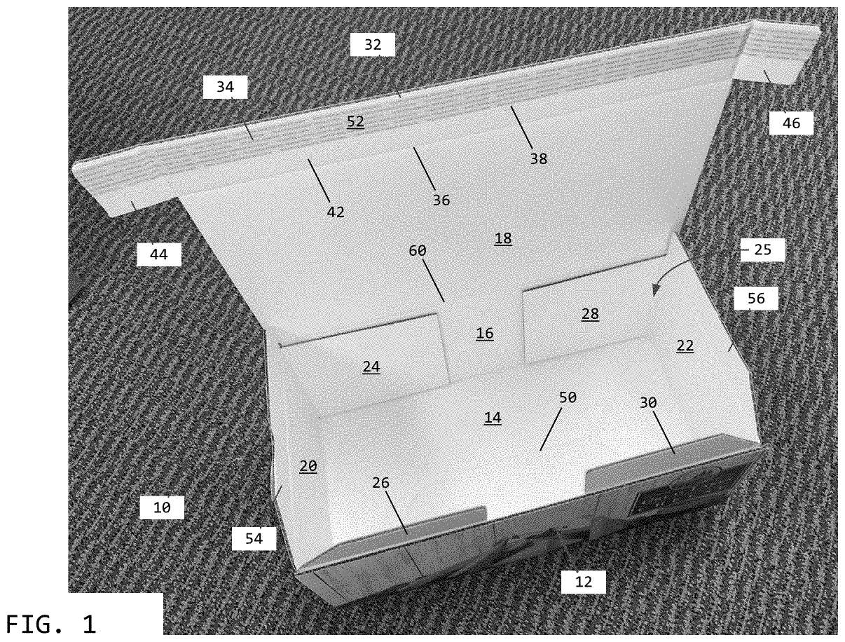

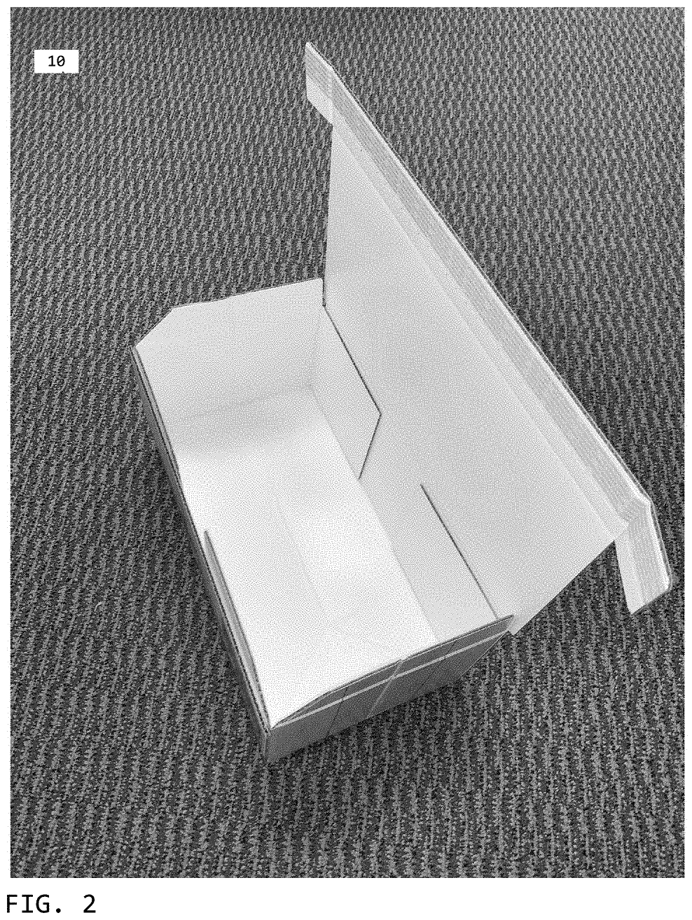

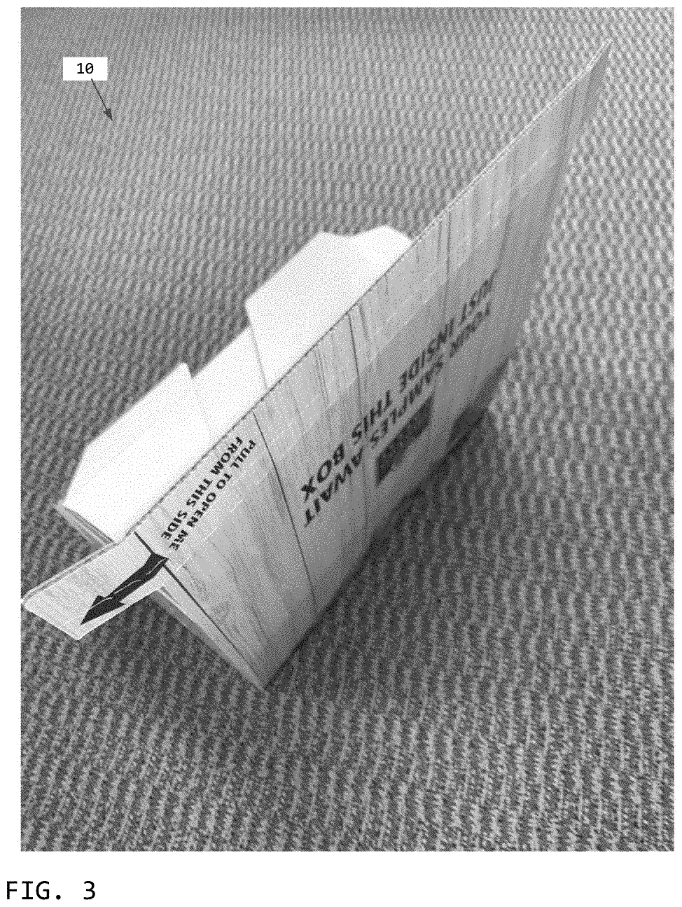

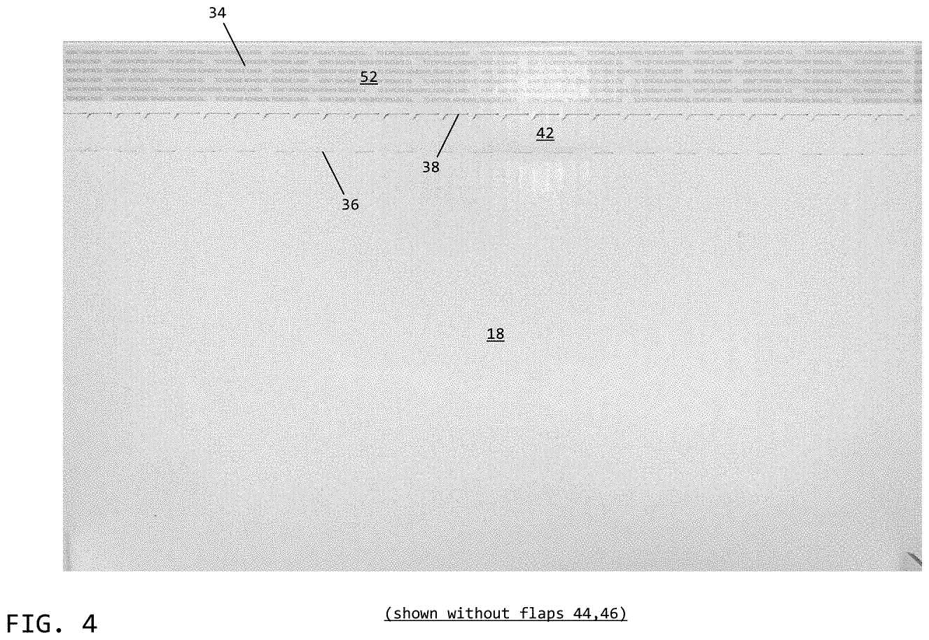

Turning now to FIGS. 1-3, perspective views of a preferred embodiment of a box 10 in accordance with one or more aspects and features of the invention are seen. FIG. 1 is a perspective front view of the box 10; FIG. 2 is a perspective side view of the box 10; and FIG. 3 is a rear perspective view of the box 10. Additionally, FIG. 4 is a close-up view of a portion of the underside of the top panel 18 of the box 10.

With particular reference to FIG. 1, the box 10 comprises a front panel 12; a bottom panel 14; a rear panel 16; a top panel 18; and side lateral panels 20,22. The first side panel 20 includes a first side flange 54 and is on a first lateral side of the box 10, and the second side panel 22 includes a second side flange panel 56 and is on a second lateral side of the box 10 opposite to the first lateral side. The box 10 further comprises first connecting panel 24; second connecting panel 26; third connecting panel 28; and fourth connection panel 30. The bottom panel 14; first and second side panels 20,22; front panel 12; and rear panel 16 define an interior space 25 of the box 10, and the top panel 18 defines a lid for covering the interior space 25.

The top panel 18 comprises a front tab 32 connected thereto. The front tab 32 comprises an adhesive strip 34 laterally extending across a distal portion of the front tab 32 for securing the front tab to the front panel 12 when the lid covers the interior space 25; and parallel lines of perforations 36,38 extending across a proximal portion of the front tab 32, the lines 36,38 defining a tear strip 40 therebetween for releasing the top panel 18 from the front panel 12 when adhered thereby by the adhesive strip 34. The front tab 32 further preferably includes flaps 44,46 that fold and secure the front tab respectively to the first and second side panels 20,22 as well. The front tab 32 also includes a protective liner 52 that is peelable to expose the adhesive strip 34 when the front tab 32 is read to be adhered to the front panel 12.

In each of these drawings, the top panel 18 is seen in an upright position with the box 10 in an “open” configuration. In the open configuration, the box 10 may be collapsed by folding along a fold line 50 that laterally bisects the box 10 for storage and transport of the box 10 prior to packing. When ready for packing, the box 10 may be “popped” into the open configuration for packing.

Once packed, the box 10 is transitioned to a “closed” configuration by folding the top panel 18 along fold line 60 into a closed position covering the interior space 25 of the box 10. The top panel 18 thereby serves as a lid and it is securely retained in this position by peeling away the liner 52 of the adhesive strip 34 adhered to the underside of the top panel 18. Once securely sealed by adhering the lid to the front panel and preferably the flaps to the side panels, the interior space 25 of the box 18 cannot be accessed for removing contents therefrom. The top panel 18 then is released from the front panel 12 by tearing away tear strip 42 when the box 10 is to be opened.

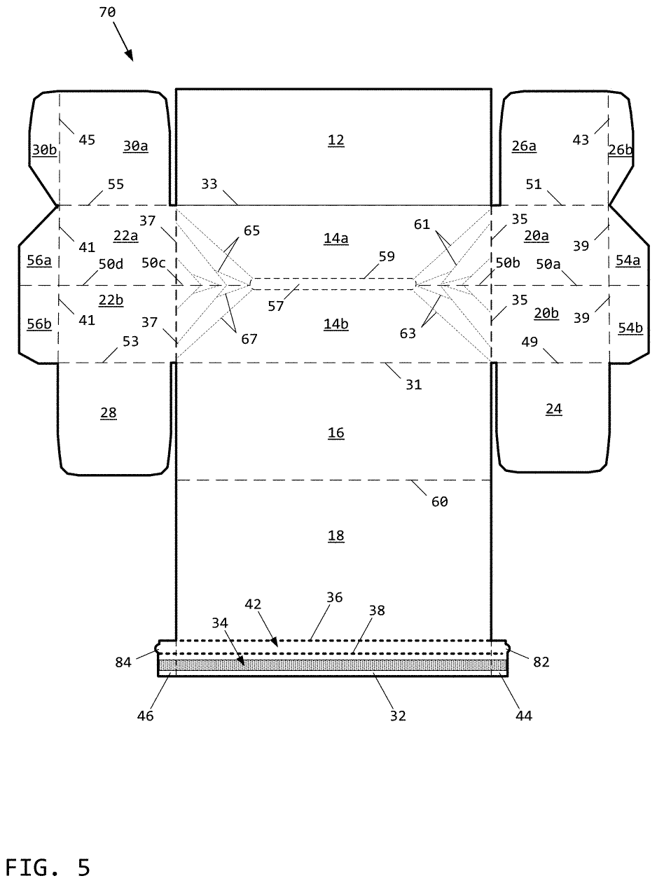

FIG. 5 is a schematic illustration of a blank 70 for making a box similar to that of box 10 by folding and gluing. Like box 10, the blank 70 includes front panel 12, rear panel 16, and top panel 18. As perhaps best seen in FIG. 5, the blank 70 includes bottom subpanels 14a,14b forming the bottom panel; first side subpanels 20a,20b forming the first side panel; second side subpanels 22a,22b forming the second side panel; connecting subpanels 26a,26b forming the second connecting panel; connecting subpanels 30a,30b forming the fourth connecting panel; first side flange subpanels 54a,54b forming the first side flange panel; and first side flange subpanels 56a,56b forming the first side flange panel.

Additionally, a fold line 31 extends and defines a common boundary between the rear panel 16 and the bottom subpanel 14b; a fold line 33 extends and defines a common boundary between the front panel 12 and the bottom subpanel 14a; a fold line 35 extends and defines a common boundary between the first side subpanel 20a,20b and the bottom subpanel 14a,14b; a fold line 37 extends and defines a common boundary between the second side subpanels 22a,22b and the bottom subpanels 14a,14b; a fold line 39 extends and defines a common boundary between the first side subpanels 20a,20b and the flange subpanels 54a,54b; a fold line 41 extends and defines a common boundary between the second side subpanels 22a,22b and the flange subpanels 56a,56b; a fold line 43 extends and defines a common boundary between the second connecting subpanels 26a,26b and the flange subpanels 54a,54b; a fold line 45 extends and defines a common boundary between the fourth connecting subpanels 30a,30b and the flange subpanels 54a,54b; fold line 49 extends and defines a common boundary between the first side subpanel 20b and connecting panel 24; fold line 51 extends and defines a common boundary between the first side subpanel 20a and connecting subpanel 26a; fold line 53 extends and defines a common boundary between the first side subpanel 22b and connecting panel 28; and fold line 55 extends and defines a common boundary between the second side subpanel 22a and connecting subpanel 30a.

Fold line 50 that bisects the box 10 for collapsing when assembled, seen in FIG. 1, is represented in FIG. 5 by fold lines 50a,50b,50c,50d, wherein fold lines 50b,50c are joined by rectangular portion 57 defined by fold line 59, which outlines a rectangular area of the bottom panel. To facilitate collapsing of the assembled box 10, minor score lines 61,63,65,67 also are provided in the bottom panel, which form triangular patterns.

Continuing with reference to blank 70, the adhesive strip 34 extends completely across the proximal portion of the front tab 32 between and including flaps 44,46. The front tab 32 is connected to the top panel 18 by perforated line 36, which extends and defines a boundary therebetween. Additionally, perforated line 36 and perforated line 38 define the tear-off strip 42. Gripping portions 82,84 facilitate initiating of tearing of the tear strip along the perforated lines 36,38, with each gripping portion 82,84 comprising a protuberance that extends beyond a respective lateral side edge of the front tab 32.

The sheet material forming the blank 70 is preferably is corrugated and, more preferably, is corrugated cardboard. Additionally, the perforations may extend through the sheet of material or may not extend through the sheet of material.

Based on the foregoing description, it will be readily understood by those persons skilled in the art that the present invention has broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof

What is claimed is:

1. A box, comprising:
(a) a sheet material defining,
(i) a bottom panel;
(ii) first and second side panels, the first side panel being on a first lateral side of the box and the second side panel being on a second lateral side of the box opposite to the first lateral side;
(iii) a front panel;
(iv) a rear panel; and
(v) a top panel;
(b) wherein the bottom panel, first and second side panels, front panel, and rear panel define an interior space of the box, and the top panel defines a lid for covering the interior space;
and (c) wherein the top panel comprises a front tab, the front tab comprising,
(i) an adhesive strip laterally extending across a distal portion of the front tab for securing the front tab to the front panel when the lid covers the interior space; and
(ii) parallel lines of perforations extending across a proximal portion of the front tab, the lines of perforation defining a tear strip for releasing the top panel from the front panel.

2. The box of claim 1, wherein the adhesive strip comprises a protective liner that is peelable.

3. The box of claim 1, wherein the adhesive strip extends completely across the proximal portion of the front tab from the first lateral side to the second lateral side.

4. The box of claim 1, wherein the tear strip defines a gripping portion for initiating tearing of the tear strip along the parallel lines of perforations.

5. The box of claim 1, wherein the gripping portion comprises a protuberance that extends beyond a lateral side edge of the front tab.

6. The box of claim 1, wherein,
(i) a fold line extends and defines a common boundary between the rear panel and the bottom panel;
(ii) a fold line extends and defines a common boundary between the front panel and the bottom panel;
(iii) a fold line extends and defines a common boundary between the first side panel and the bottom panel;
(iv) a fold line extends and defines a common boundary between the second side panel and the bottom panel; and
(v) a fold line extends and defines a common boundary between the rear panel and the front tab.

7. The box of claim 1, wherein the first side panel comprises two subpanels having a fold line extending and defining a common boundary therebetween.

8. The box of claim 7, wherein the first side panel further comprises two flange subpanels having a fold line extending and defining a common boundary therebetween.

9. The box of claim 1, wherein the second side panel comprises two subpanels having a fold line extending and defining a common boundary therebetween.

10. The box of claim 9, wherein the second side panel further comprises two flange subpanels having a fold line extending and defining a common boundary therebetween.

11. The box of claim 1, wherein the sheet material further defines first and second connecting panels, each of the first and second connecting panels having a respective fold line extending and defining a boundary between it and the first side panel.

12. The box of claim 11, wherein the sheet material further defines third and fourth connecting panels, each of the third and fourth connecting panels having a respective fold line extending and defining a boundary between it and the second side panel.

13. The box of claim 12, wherein the first connecting portion further comprises a flange subpanel having a fold line extending and defining a boundary between it and the first connection portion;
and wherein the third connecting portion further comprises a flange subpanel having a fold line extending and defining a boundary between it and the second connection portion.

14. The box of claim 1, wherein the sheet material is corrugated.

15. The box of claim 1, wherein the sheet material is corrugated cardboard.

16. The box of claim 1, wherein the perforations extend through the sheet of material.

17. The box of claim 1, wherein the perforations do not extend through the sheet of material.

18. The box of claim 1, wherein the bottom panel comprises minor score lines facilitating collapsing of the box when in an assembled state.

19. A method of making a box blank, comprising:
(a) forming fold lines in a single sheet of material such that the single sheet of material comprises:
(i) a bottom panel;
(ii) first and second side panels, the first side panel being on a first lateral side of the box and the second side panel being on a second lateral side of the box opposite to the first lateral side;
(iii) a front panel;
(iv) a rear panel;
(v) a top panel; and
(vi) a front tab, wherein the front tab is connected to the top panel with a first line of perforations and wherein the front tab further comprises another line of perforations extending across a proximal portion of the front tab, the lines of perforations defining a tear strip; and
(b) adhering an adhesive strip to a distal portion of the front tab such that the adhesive strip laterally extends across the distal portion of the front tab from the first lateral side to the second lateral side.

20. A method of securing a box for shipping, the box comprising,
a sheet material defining,
a bottom panel;
first and second side panels, the first side panel being on a first lateral side of the box and the second side panel being on a second lateral side of the box opposite to the first lateral side;
a front panel;
a rear panel; and
a top panel;
wherein the top panel comprises a front tab, the front tab comprising, an adhesive strip laterally extending across a distal portion of the front tab; and
parallel lines of perforations extending across a proximal portion of the front tab, the lines of perforation defining a tear strip, comprising:
the method comprising,
(a) folding the top panel into covering relation to an interior space defined by the side panes, rear panel, front panel, and bottom panel;
(b) adhering the distal portion of the front tab of the top panel to the front panel, including peeling off the liner from the adhesive strip, folding the front tab over a top edge of the front panel, and pressing the adhesive strip on the distal portion of the front tab into engagement with an outer surface of the front panel to secure the front tab to the front panel and the top panel in covering relation to the interior space of the box.
